(19) United States
(12) Patent Application Publication
(10) Pub. No.: US 2026/0250470 A1
(43) Pub. Date: Aug. 27, 2026

(54) FACILE MATERIAL EXTRUSION OF 3D WEARABLE CONDUCTIVE-POLYMER MICRO-SUPER-CAPACITORS

(71) Applicant: THE GOVERNING COUNCIL OF THE UNIVERSITY OF TORONTO, Toronto (CA)

(72) Inventors: Terek Li, Richmond (CA); Hani E. Naguib, Toronto (CA)

(21) Appl. No.: 19/271,276

(22) Filed: Jul. 16, 2025

Related U.S. Application Data
(60) Provisional application No. 63/671,861, filed on Jul. 16, 2024.

(51) Int. Cl. C08J 3/075; C08J 3/205; H01G 11/48; H01G 11/68; H01G 11/86

(52) U.S. Cl. CPC C08J 3/075; C08J 3/205; H01G 11/48; H01G 11/86; C08J 2481/08; H01G 11/68

(57) ABSTRACT

Disclosed herein is a strategy to rapidly synthesize MEX-compatible CP gel from PEDOT:PSS dispersion using Super-Absorbent-Polymers (SAP) beads is reported. Excessive water from the initial 1.3 wt% aqueous dispersion is removed to form a thick paste, followed by controlled re-dispersion in a mixture of water with the secondary dopant DMSO. The final CP ink exhibits superior and highly reproducible printability with an achieved feature size of 250 μm and layer thickness of 230 μm. Dry annealing of the printed CP structures provides high electrical conductivity of over 400 S cm⁻¹ while maintaining the intrinsic flexibility of PEDOT:PSS. The developed ink is used to print multi-layered micro-super-capacitors (MSCs) with outstanding electrochemical performance and stability over time. The ability for MEX to effortlessly fabricate complex patterns with 3D structuring is shown to drastically increase the areal energy density of MSCs. Moreover, the printed material demonstrates excellent cohesion between subsequent layers, which is the underlying mechanism for 3D MSCs to ensure stable energy density at a fast discharge rate.

### FIELD

The present disclosure relates to a strategy to rapidly synthesize MEX-compatible CP gel from PEDOT:PSS dispersion using Super-Absorbent-Polymers (SAP) beads.

### BACKGROUND

Conductive polymers (CP), such as poly(3,4-ethylenedioxythiophene) polystyrene sulfonate (PEDOT:PSS), intrinsically offer a high electrical conductivity [1], desirable biocompatibility [2], and enhanced stability [3]. These enabled CP as a promising material for a wide range of applications, including energy harvesting and storage [4-6], actuation [7-9], and sensing [10-13]. To date fabrication of CP structures has been traditionally limited to conventional techniques such as inkjet printing [14], [15], screen printing [16], aerosol-jet printing [17], [18], electrochemical patterning [19] and lithography [20], [21]. These techniques could only produce 2D film-like structures with a thickness of several micrometers, which severely limits the potential applications of CP [22]. Furthermore, the complex fabrication procedures and long processing times increase the difficulty to translate from material to functional device, thus, hindering rapid innovation. Compared to the fabrication methods mentioned, Material Extrusion (MEX) is a simple, versatile, and rapid printing technique that can print both thin-film structures as well as 3D structures with the thickness on the order of millimeter at sub-10 μm resolution. MEX uses applied mechanical force to extrude colloidal gel-like material in a layer-by-layer fashion.

To be compatible with MEX, the material must first demonstrate shear thinning behavior in which viscosity decreases with increasing applied stress to ensure it can be ejected smoothly from a narrow nozzle [23]. The material then needs to feature a favorable viscoelastic behavior to form mechanically stable architectures without collapsing or overspreading [24]. Despite successful implementation of MEX with materials such as graphene, MXene, carbon-nano-tubes (CNT), cellulose, and ceramics [25-27], incorporation of MEX with CP has been a major challenge as the latter is typically synthesized in the liquid phase [28], [29]. Such low viscosity hampered CP's ability to be used for MEX. One method to use CP for MEX is additive-induced physical crosslinking, which promotes room temperature gelation of pristine CP solution to reach the desired viscosity for deposition. Additives such as dimethyl sulfoxide (DMSO), Triton X-100, and dodecylbenzenesulfonic acid (DBSA) have all been used for such purposes with exceptional print fidelity [30], [31].

However, such approach offers a narrow timeframe for printing as the gelation reaction is continuous and could eventually renders the gel unprintable. Ultimately, fast formation of pristine CP gel with long term stability and favorable rheological properties are required. In 2020 Yuk et al. pioneered MEX of pristine CP by freeze-drying PEDOT:PSS solution followed by re-dispersion by planetary mixing. The obtained CP gel demonstrated stable viscosity and yield stress after 40 days of storage. Devices such as soft neural probes were successfully printed using this strategy [32]. Later in 2021 Xin et al. compared the ability of baked-dried versus freeze-dried PEDOT:PSS to redisperse in an aqueous medium, and concluded that the heat-induced winding of molecular chains created large aggregates upon re-dispersion. There-fore, freeze-drying was recognized as the only viable solution to prepare re-dispersible PEDOT:PSS [33]. Indeed, all later attempts in MEX of pristine CP followed Yuk et al.'s approach in which the solid content of freeze-dried PEDOT:PSS was adjusted to obtain a viscous gel [34-36].

However, freeze-drying is a time-intensive approach as the water content in ~1 solid wt % of CP dispersion must be sublimed, which requires around 72 h [32]. This shortcoming severely impeded rapid innovations and the ability to transform CP from material to device. Since CP is typically synthesized in liquid form, therefore, there is a need for a novel strategy to prepare MEX-compatible CP-based ink directly from the liquid state.

### SUMMARY

Disclosed herein is a strategy to rapidly synthesize MEX-compatible CP gel from PEDOT:PSS dispersion using Super-Absorbent-Polymers (SAP) beads is reported. Excessive water from the initial 1.3 wt % aqueous dispersion is removed to form a thick paste, followed by controlled re-dispersion in a mixture of water with the secondary dopant DMSO. The final CP ink exhibits superior and highly reproducible printability with an achieved feature size of 250 μm and layer thickness of 230 μm. Dry annealing of the printed CP structures provides high electrical conductivity of over 400 S cm⁻¹ while maintaining the intrinsic flexibility of PEDOT:PSS. The developed ink is used to print multi-layered micro-super-capacitors (MSCs) with outstanding electrochemical performance and stability over time. The ability for MEX to effortlessly fabricate complex patterns with 3D structuring is shown to drastically increase the areal energy density of MSCs. Moreover, the printed material demonstrated excellent cohesion between subsequent layers, which is the underlying mechanism for 3D MSCs to ensure stable energy density at a fast discharge rate.

The printed MSCs have been shown to charge through both alternating current (AC) and direct current (DC) mobile energy sources, powering a wide variety of wearable electronic devices, including temperature sensors, illuminating wristbands, location tracking devices, and electrocardiogram sensors. Overall, the rapidly printable CP ink preparation technique, in conjunction with the demonstrated exceptional performance of MEX printed 3D CP-based devices significantly improved the overall process to transform CP from material to device. This enables advanced rapid innovations and inspire new research interests in expanding CP's application space.

The present disclosure provides a method of preparing a flowable electrically conductive PEDOT:PSS polymeric gel that comprises adding macroscopic super-absorbent particles to an aqueous liquid PEDOT:PSS solution to form a mixture. The method includes extracting water from the mixture by incubating the mixture at a preselected temperature for a preselected period of time for allowing the macroscopic super-absorbent particles to absorb the water to a preselected saturation of the macroscopic super-absorbent particles to produce a the flowable electrically conductive PEDOT:PSS polymeric gel. The water-saturated macroscopic super-absorbent-particles are then removed from the PEDOT:PSS polymeric gel.

About 3 to about 6 grams of macroscopic super-absorbent particles may be added to about 80 to about 150 grams of the aqueous liquid PEDOT:PSS solution.

About 4 grams of macroscopic super-absorbent particles may be added to about 100 grams of the aqueous liquid PEDOT:PSS solution.

The mixture may be incubated at a temperature in a range from about 5 to about 40 degrees Celsius.

The preselected period of time may be in a range from about 2 to about 12 hours.

The method may further comprise adding a dopant into the flowable electrically conductive PEDOT:PSS polymeric gel, the dopant selected to increase the electrical conductivity of the flowable electrically conductive PEDOT:PSS polymeric gel.

The dopant may be any one or combination of ethylene glycol, diethylene glycol, dimethyl sulphate, tetrahydrofuran, dimethylformamide, glycerol, methanol, ethanol, and acetone.

The dopant may be dimethyl sulfoxide.

The flowable electrically conductive PEDOT:PSS polymeric gel may be characterized by having a viscosity of between about 500 to about 1000 Pascal seconds, and further comprising diluting to a viscosity in a range from about 10 to about 500 Pascal seconds. The flowable electrically conductive PEDOT:PSS polymeric gel may be diluted to give a viscosity in a range from about 100 to about 200 Pascal seconds.

The macroscopic super-absorbent particles may be macroscopic super-absorbent beads.

The macroscopic super-absorbent particles may be any one or combination of sodium polyacrylate in the form of beads, gel, fiber, and or film.

The present method provides a product producing using the above-mentioned method.

### BRIEF DESCRIPTION OF THE DRAWINGS

Embodiments will now be described, by way of example only, with reference to the drawings, in which:

FIG. 1 is an Illustration of preparation process to transform CP liquid dispersion to viscous gel. SAP beads expand in size as excess water is imbibed. After beads are removed the viscoelasticity of the gel enables it to be used for MEX by extruding out of a narrow nozzle;

FIGS. 2A to 2J show the development of MEX compatible CP ink, in which:

FIG. 2A shows TGA results showing the change in concentration of CP before and after SAP beads treatment,

FIG. 2B shows SAXS characterization of CP ink at various concentration,

FIG. 2C shows the apparent viscosity at 1 s⁻¹ shear rate and calculated D-spacing between nano-fibrils versus CP concentration,

FIG. 2D shows viscosity sweeps over changing shear rate of CP at various concentration. e) Change in yield stress of PEDOT:PSS ink,

FIG. 2F shows the relationship between contact angle and Elastic Modulus (G′) in the Linear Viscoelastic Region (LVR),

FIGS. 2G, 2H, 2], 2J show the change in print quality as concentration increased from 1.3 to 9 wt %. All prints are performed using 22 G nozzle at constant flow rate of 100 μL min⁻¹ and travel speed of 200 mm min⁻¹, maple leaves are printed on Kapton substrate, and contact angles are measured on glass substrate.

FIGS. 3A to 3E show an electrical optimization and printing demonstration in which:

FIG. 3A shows the change in yield stress and electrical conductivity over different DMSO to PEDOT:PSS ratio.

FIG. 3B shows FTIR results showing effect of DMSO. FIG. 3C is a graphical illustration of the effect of DMSO, FIG. 3D is a printing simulation showing the change in viscosity during different phases. 0.1 and 100 s⁻¹ shear rate is applied to the rest and yield phase respectively, FIG. 3E is a printed single layer “University of Toronto” text with scale bar is 1 cm, and FIG. 3F is a printed overhanging structure with scale bar is 1 cm.

FIGS. 4A to 4I show an electrochemical characterization of printed multilayer MSCs in which:

FIG. 4A shows optical images of as-printed 10-layer micro-super-capacitors (MSCs), wherein the lower image shows an overall view of a MSC and the upper image shows a magnified view of the MSC,

FIGS. 4B to 4D show electrochemical comparisons of 1, 2, 4, and 6-layer MSCs with FIG. 4B showing CV curves at 5 mV s⁻¹ scan rate,

FIG. 4C shows CD curves at 0.05 mA cm⁻² current density,

FIG. 4D shows areal capacitance versus scan rate,

FIG. 4E shows linear increase in areal capacitance over increasing printed layers,

FIG. 4F shows an SEM image of cross section of 6-layers MSC,

FIG. 4G shows an EIS plot,

FIG. 4H shows charge retention of 6-layer MSC after 10,000 cycles, and

FIG. 4I shows a Ragone plot of 6-layers MSC and performance comparison against literature, with data obtained from Refs. [63-71].

FIGS. 5A to 5G show a demonstration of wearable electronic devices powered by 6-layer MSCs in which:

FIG. 5A shows a luminous intensity comparison of a LED wristband powered by constant DC supply versus by three MSCs,

FIG. 5B shows a smart tracking device powered by three MSCs,

FIG. 5C shows change in voltage and display intensity of a temperature sensor with LCD display powered by two MSCs,

FIG. 5D shows a setup of ECG sensor powered by five MSCs,

FIG. 5E shows measured heartbeat per minute and

FIG. 5F shows the corresponding ECG signal of FIG. 5E, and

FIG. 5G shows different number of MSCs charged by solar panels.

FIG. 6 shows an elastic stress versus dynamic strain of CP ink at various PEDOT:PSS concentration. Elastic stress is calculated as σ′=G′×γ, where G′ and γ corresponds to storage modulus and strain respectively. The absolute maximum of σ′ is the yield stress as marked by the dotted grey line.

FIG. 7 shows a self-assembled Direct Ink Writing Printer based on progressive cavity pump printhead from Viscotec Vipro 3. Print material is fed pneumatically into the dispenser. Control unit controls the gantry and dispenser according to GCode commands.

FIGS. 8A to 8D show SEM images of the surface of super-absorbent-polymer (SAP) beads at various magnifications, illustrating a fully dense morphology, wherein FIG. 8A is at 35× magnification, FIG. 8B is at 190× magnification, FIG. 8C is at 400× magnification, and FIG. 8D is at 1,800× magnification.

FIG. 9A to 9I show the rheological characterizations of CP inks with varying PEDOT:PSS concentration. Storage and loss modulus are reported as a function of shear strain from 1 to 9 wt %.

FIG. 10 shows Change in contact angle of CP ink at various PEDOT:PSS concentration from 1 to 9 wt % on glass substrate.

FIG. 11 shows the change in print quality of CP ink at various PEDOT:PSS concentration from 1 to 9 wt %. The print path is shown in top left. Same volumetric flow rate and gantry travel speed is used for all prints.

FIG. 12 shows a quantification of resulting linewidth and contact angle of printed CP ink at various PEDOT:PSS concentration.

FIG. 13 shows the viscosity comparison of 7 wt % ink at different DMSO:(CP) weight ratio. The viscosity decreased as weight ratio increased.

FIG. 14 shows the Raman Spectroscopy result of 7 wt % PEDOT:PSS ink with and without DMSO.

FIGS. 15A to 15D show the rheological characterization of 7 wt % CP ink with varying DMSO:(PEDOT:PSS) weight ratio from 1 to 6.

FIGS. 16A and 16B show the dynamic simulation of change in rheology during printing. Rest phases correspond to a low shear strain of 1% simulating condition after ink deposition. Yield phases correspond to high shear strain of 500% simulating extrusion during ink deposition. A constant angular frequency (ω)) of 1 rad s⁻¹ is applied for both phases. tan (δ) is calculated as the ratio between loss modulus and storage modulus, with FIG. 16A showing change in loss and storage modulus and FIG. 16B showing the corresponding change in tan (δ).

FIG. 17 shows the change in thickness over increasing printed layers.

FIGS. 18A to 18D show the detailed electrochemical characterization of a 1-layer MSC in FIGS. 18A and 118B, and a 2-layer MSC in FIGS. 18C and 18D.

FIGS. 19A to 19D show the detailed electrochemical characterization of a 4-layer MSC in FIG. 19A and FIG. 19B 4-layer MSC, and 6-layer MSC shown in FIG. 19C and FIG. 19D.

FIG. 20 shows the change in MSCs electrodes width and distance between electrodes over number of printed layers.

FIGS. 21A and 21B show the electrochemical characterization of 2-layer MSC printed by adjusting the distance between electrodes to the same as 1-layer MSC at 563.4 μm in which in FIG. 21A the CV curve demonstrates nearly identical behaviour and areal capacitance as the original 2-layer MSC, and in FIG. 21B the ESR slightly increased from 82Ω of the original MSC to 102Ω due to the increased ion transport pathway, but is not sufficient to change the electrochemical behaviour of the MSC.

FIGS. 22A to 22A show the CV curve of 6-layers MSC at 5 mV s⁻¹ scan rate, in which FIG. 22A shows it while being manually bent at different orientations, FIG. 22B shows it after different bending cycles in the x-direction, and FIG. 22C shows an image illustrating bending of MSC with a radius of curvature of 0.16 cm⁻¹.

FIG. 23 shows the CV curve for 6-layer MSC at 5 mV s⁻¹ scan rate for stability test between 1^{st} and 10000^{th} cycles with increment of 500 cycles.

FIG. 24 shows the readings from the LCD display of wearable temperature sensor. The reading reacted spontaneously after sensor is in contact with warm water.’

FIG. 25 shows the measured voltage across two MSCs (top) being charged by the output of an electromagnetic induction-based squeeze handle generator (bottom). The magnet is manually spun at approximately 2 Hz.

### DETAILED DESCRIPTION

Various embodiments and aspects of the disclosure will be described with reference to details discussed below. The following description and drawings are illustrative of the disclosure and are not to be construed as limiting the disclosure. The drawings are not necessarily to scale. Numerous specific details are described to provide a thorough understanding of various embodiments of the present disclosure. However, in certain instances, well-known or conventional details are not described in order to provide a concise discussion of embodiments of the present disclosure.

### Definitions

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. Unless otherwise specified, the terms “about” and “approximately” mean plus or minus 25 percent or less. It is not the intention to exclude embodiments such as these from the present disclosure.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

### Material and Methods

### Conductive Polymer Ink Preparation:

All chemicals are used as received without further purification. Commercially available PEDOT:PSS aqueous dispersion (PH1000, Clevios™) is stirred at 500 rpm for 30 min before use. Super-absorbent-polymer (SAP) beads (QMays) is purchased from Amazon. Approximately 8 g of SAP beads are added to 200 mL of PEDOT:PSS dispersion and set still at room temperature with occasional stirring. After 6 h the highly concentrated thick paste is collected. Initial concentration after SAP beads treatment is determined using Thermal Gravimetric Analysis (TGA) (Q50, TA-Instrument) beginning from room temperature, ramped to 100° C. and held for 2 h. DMSO and water are then added to form ink with various formulation. The paste is first repeatedly extruded out of a nozzle to form a uniform ink, then it is centrifuged at 4000 rpm for 5 min to remove air bubbles.

### Small Angle X-Ray Scattering (SAXS) Measurements

SAXS characterizations of the prepared inks are performed using Automated Small/Wide Angle X-ray Scattering (SAXSpace, Anton Paar) with sample to detector distance of 317.07 mm and exposure time of 300 s.

The measured scattering intensity (q) is corrected by subtracting the solvent (water) and cell background. 10 μL quartz capillary cell is used for ink at 1 wt %, and Paste Cell is used for all remaining ink concentrations. The D-spacing (d) between nano-fibrils is calculated by the Bragg expression L=2π/qmax without further fitting of the SAXS data.

### Rheological Measurements

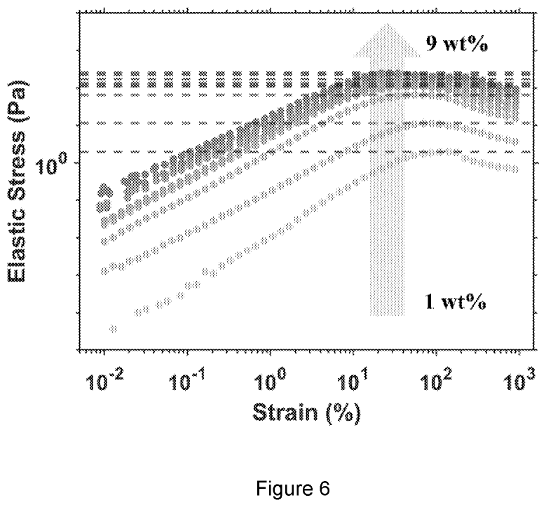

Rheological characterizations of the inks are conducted by using a rotational rheometer (MCR702, Anton Paar) with 25 mm diameter steel parallel-plate geometry and 0.5 mm gap distance. Apparent viscosity is measured as a function of shear rate by steady-state flow tests with a logarithmic sweep of shear rate from 0.1 to 100 s⁻¹. Shear storage modulus (G′) and loss modulus (G″) are measured via dynamic strain (γ) sweep from 0.1% to 1000% at 1 rad s⁻¹ ω. Yield stress for each sample is determined as the absolute maximum of elastic stress (σ′=G′×γ) (FIG. 6) [37]. All rheological characterizations are conducted at room temperature with preliminary equilibrium time of ten minute.

### Material Extrusion

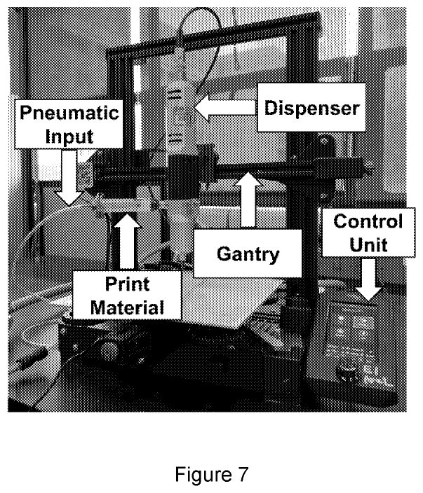

Printing is performed with a custom assembled printer (FIG. 7). The printhead (Vipro 3, Viscotec) uses progressive cavity pump principal to dose viscous material and allows for linear control of volumetric flow rate, which enabled printing of various con-centration ink at controlled setting. The printhead is mounted onto a modified printer (Ender 3 V2, Creality) with a custom designed bracket. Inks are stored inside a 10 cc syringe and fed into the dispenser pneumatically at six atmospheric pressures. Various sizes of print nozzles (22 G and 25 G) are used. All printing consumables are supplied by Nordson Corporation. Kapton films, glass slides and polyethylene-terephthalate (PET) films are used as print substrate and are cleaned subsequently with ethanol and water before use. 3D models are created using SolidWorks, and corresponding print paths are generated using Cura with a customized slicing profile. The volumetric flow rate is calculated and adjusted using a customized MATLAB script. 50 μL min⁻¹ flow rate and travel speed of 650 mm min⁻¹ are used as print parameters unless otherwise stated. Printed samples are first annealed at 60° C. for 15 min to evaporate water, and then at 130° C. for 30 min in a fume hood to evaporate DMSO.

### Fabrication of Solid State MSCs:

The gel electrolyte is prepared by fully dissolving 1 g of 99% hydrolyzed poly(vinyl alcohol) (Sigma Aldrich) in 10 g of deionized water at 90° C. while stirring at 600 rpm. After the solution cooled down to room temperature 1 mL of H₂SO₄ (Sigma Aldrich) is slowly added to control the exothermic reaction. The gel electrolyte is casted onto the printed MSCs using a brush, after which the sample is dried overnight.

### Electrical Characterization:

The electrical conductivities of the printed samples are measured using a 4-point probe method with the Alpha-N High Resolution Dielectric Analyzer from Novocontrol Technologies. Eq. 1 is used to determine sample conductivity. The resistivity is first calculated using sample thickness t in cm and sheet resistance R in Ωsq⁻¹. Conductivity in S cm⁻¹ is then reported as the inverse of resistivity (σ=1/φ. A two-electrodes setup is used to characterize the electrochemical performance of assembled MSCs. Measurements are performed using a CHI6054E potentiometer. The capacitance of each MSC is first calculated using data from the CV test according to Eq. 2, where ΔV is the potential window (ΔV=V2−V1), V2 and V1 are the upper and lower bounds respectively. v is the scan rate in V s⁻¹. i is the discharge current in Ampere (A) and dV is infinitesimal changes in electrical potential. C is the capacitance of the MSC being tested in Farads.

Areal capacitance is normalized according to the active electrodes area of the MSCs.

$$P = π tR / ( ln ( 2 ) ) \qquad ( 1 )$$

$$C = \frac{1}{Δ V v} {\int }_{{V}_{1}}^{{V}_{2}} i d V \qquad ( 2 )$$

The energy and power density of assembled MSCs is calculated using capacitance and discharge time from CD data. The capacitance is first calculated from Eq. 3, where I is the applied constant current densities in Amperes cm⁻², and Δt is the discharging time.

$$C = I Δ t / E \qquad ( 3 )$$

The capacitance from CD test is used to calculate energy stored in capacitor according to Eq. 4, where E is the stored energy in Joule. Power density is determined by dividing the energy over discharge time. All assembled MSCs are subjected to CV, CD and impedance testing.

$$E = 1 / 2 C Δ {V}^{2} \qquad ( 4 )$$

### Other Testing Methods:

Contact angles measurements are performed by precisely dosing 5 μL of ink on glass substrate. Images are taken and analyzed using Ossila Contact Angle setup and software. Line width of printed maple leaves are measured by ImageJ using pixel count technique. The line width and gap width of printed MSCs are determined using optical microscope (40×-2500×, Omax). Fourier transform infrared (FTIR) (Bruker ALPHA system) and Raman Spectroscopy (Anton Paar) are performed to understand the interaction between secondary dopant and PEDOT:PSS. Scanning Electron Microscope (SEM) (Model FEG-250, Quanta) is used to study the layer cohesion. Thickness of printed films are measured using a thickness gauge (H-2781, Mitutoyo).

### Demonstration of Printed MSCs:

For charging test, solar panels (Aoshike and Uxcell, Amazon) are connected to different MSCs in series to match the voltage output. The magnetic-coil based squeeze handle generator is prepared by first removing all batteries from the system. The AC output is converted to DC through a four-bridge rectifier before charging the MSCs. The magnet is manually spun at approximately 2 Hz. The illuminating wrist band is constructed by soldering two micro litzs wired LED (Bowerful, Amazon) in parallel. The personal tracker is pre-pared by removing the coin battery from AirTag (Apple), three lead wires (two inputs and one ground) are then soldered on the original pin to establish a stable connection. Similar preparation process is carried out for the wearable temperature sensor. The output from ECG sensor (SEN0213, DFRobot) is connected to an Arduino Uno for communication with personal computer. The ECG sensor receives all energy from the printed MSCs. The informed written consent from all participants or next of kin was obtained prior to the research.

### Results and Discussion

PEDOT:PSS is typically available as a dispersion of 1.3 wt % gel particles in an aqueous form whose fluidity prevents its direct use in MEX [10], [38]. To obtain favorable rheological properties for printing, the concentration of solid content must be enriched to allow for abundant physical crosslinking between nanofibrils which exponentially in-creases ink viscosity [32]. In this work, a novel method is established to increase the solid content of CP using SAP beads. This ambient temperature approach substantially reduces processing time from 72 h using the freeze-drying method to only 6 h. SAP is loosely crosslinked hydrophilic hydrogels that can imbibe water several times its own weight through osmotic pressures [39], [40].

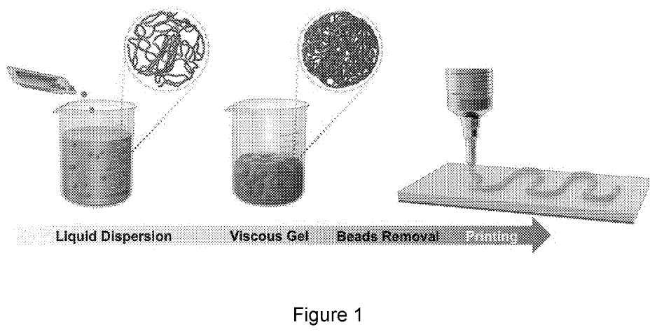

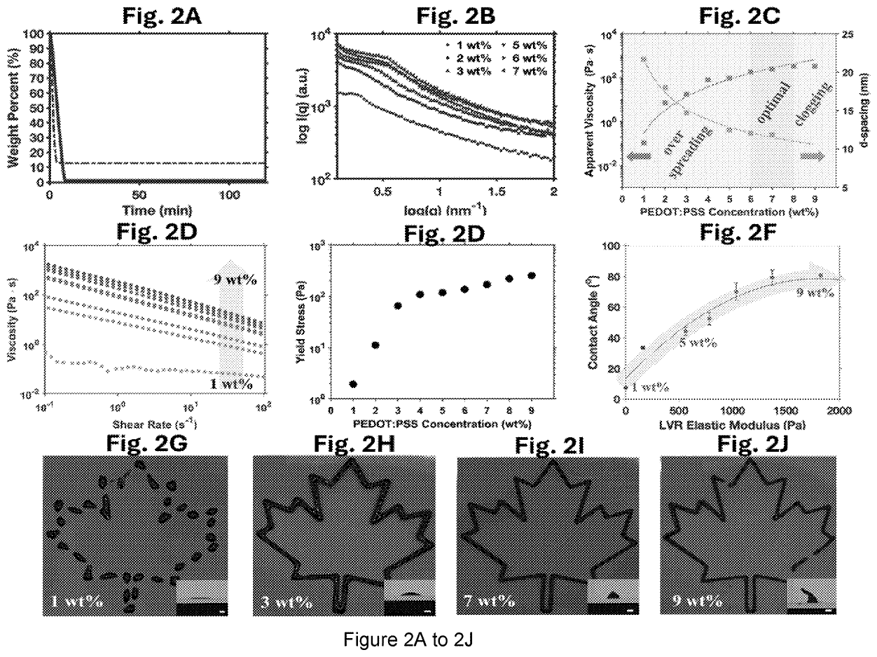

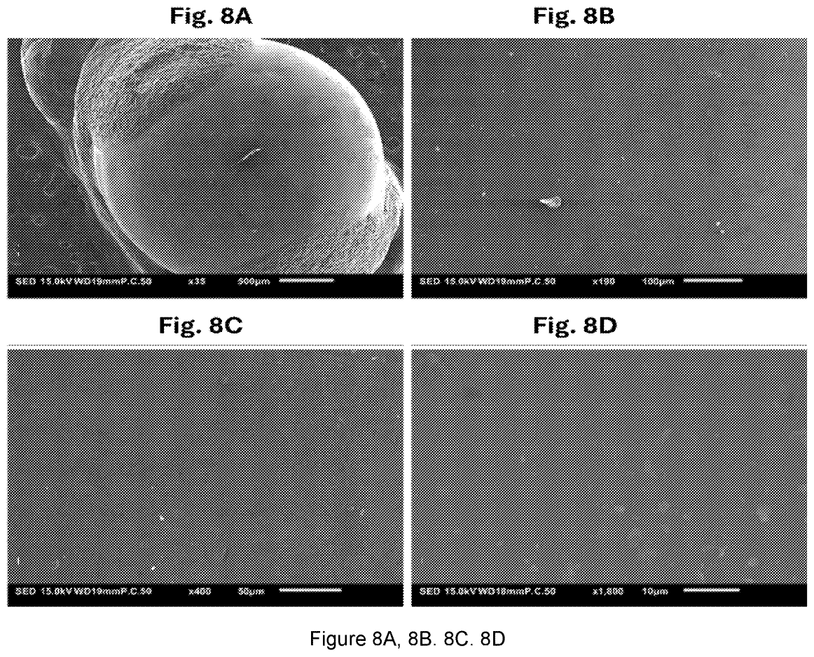

FIGS. 8a to 8d show a SEM image of the surface of Super-absorbent-polymer (SAP) beads at various magnifications showing a fully dense morphology which shows the surface of SAP beads is fully dense and does not absorb nano-flakes or nano-fibrils when immersed in a dispersion [41], [42]. Over the course of six hours the SAP beads slowly imbibe water and swell in size (FIG. 1). Consequently, the concentration of CP increased from 1.3 wt % to 12.72 wt % through reversible physical crosslinking (FIG. 2A). This highly concentrated gel can then be diluted without any aggregation to obtain CP ink with controlled solid content.

The rheology properties of the SAP beads treated ink is like that prepared via the freeze-drying method (Table 1), which further proves the capability of this novel method to rapidly prepare aggregate-free and dispersible gel through reversible physical crosslinking. Small Angle X-ray Scattering (SAXS) (FIG. 2B) is performed to monitor the microscopic evolution of the average distance (d) between CP nano-fibrils chains. This can be approximated using Bragg expression: d=2π/qmax, where qmax is the azimuth-angle values (q) at which intensity decreases due to repulsive interaction potential between polymer chains [43].

TABLE 1
Apparent viscosity and yield stress comparison between SAP
treated PEDOT:PSS gel versus freeze dried PEDOT:SS gel. Freeze
dried data is retrieved from Ref. [1]. Note that freeze
dried PEDOT:PSS is diluted using water and DMSO (85:15 v/v),
where as SAP treated PEDOT:PSS is diluted using only water.
Overall, high similarity is observed between ink prepared
via these two methods, which confirms the ability of our
demonstrated method to synthesize aggregate-free gel.

| CP Concen- | Viscosity at 1 s⁻¹ Shear Rate | | Yield Stress | |
|---|---|---|---|---|
| tration | (Pa · s) | | (Pa) | |
| (wt %) | SAP Treated | Freeze Dried | SAP Treated | Freeze Dried |
| 1 | 0.11 | 4.58 | 1.94 | 1.28 |
| 2 | 7.28 | 15.58 | 11.29 | 16.15 |
| 3 | 17.99 | 26.62 | 65.58 | 40.81 |
| 4 | 79.49 | 42.13 | 108.82 | 101.56 |
| 5 | 93.93 | 60.82 | 119.41 | 130.05 |
| 6 | 177.55 | 70.88 | 127.02 | 136.22 |
| 7 | 249.06 | 83.87 | 171.38 | 149.45 |

Nano-fibrils chains become more densely packed with increasing concentration, as evident by the decrease in D-spacing from 21.7 nm of 1.3 wt % to 11.8 nm of 7 wt %, which is inversely proportional to the increase in apparent viscosity (FIG. 2C). This led to a clear transition from low viscosity liquid to highly viscous gel as evident by the viscosity increase with shear-thinning behavior (FIG. 2D) [44]. Consequently, the calculated yield stress (FIG. 6), the point where internal structure of the material breaks down to initiate flow, increased linearly on a logarithmic scale from 1.3 to 3 wt % after which only incremental change is observed until 9 wt % (FIG. 2E). The diluted ink can be directly printed via MEX using a customized printer setup based on volumetric dosing (FIG. 7). To determine suitable formulation for printing, the Linear Viscoelastic Range (LVR) of the ink, which is the range of strain where the material behaves linearly viscoelastic with strain directly proportional to the applied stress, is determined by dynamic rheology test as shown in

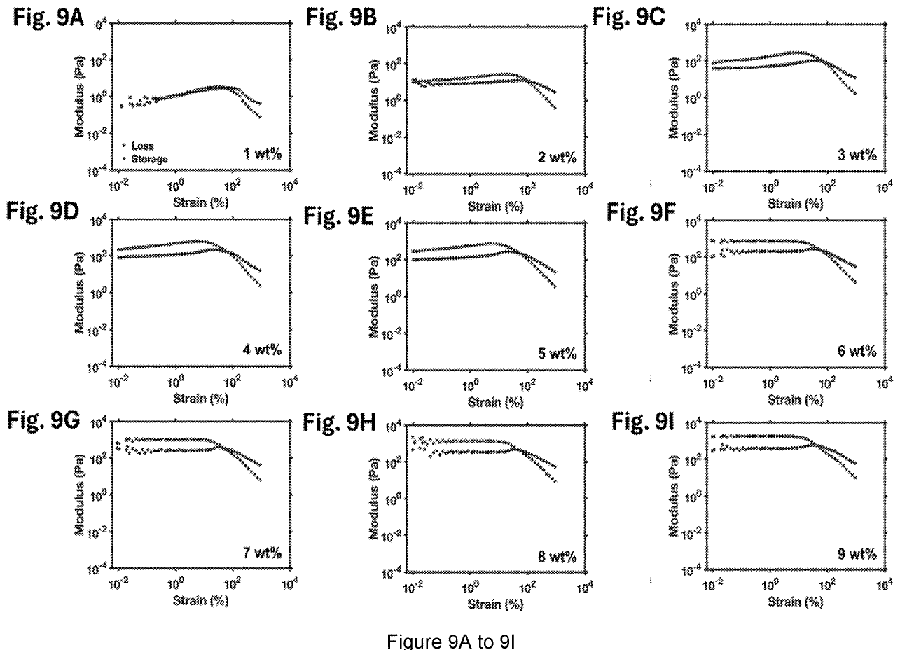

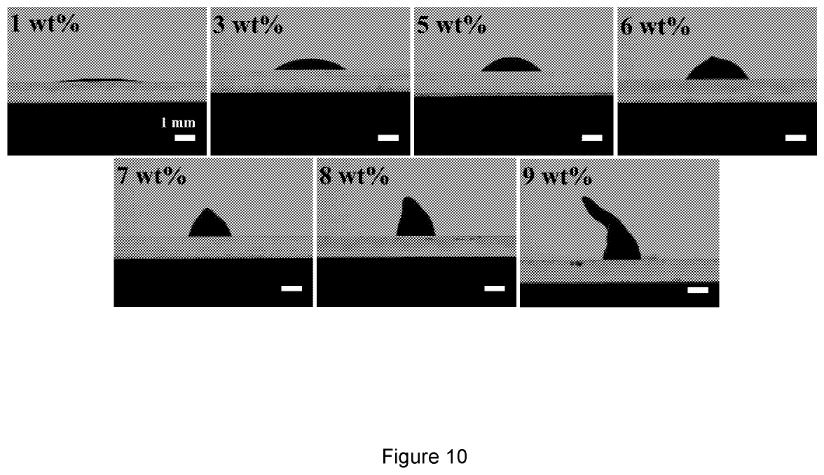

The ability for shape retention without excessive spreading after extrusion is characterized by elastic modulus (G′) which increased by three orders of magnitude with increasing concentration as shown in FIG. 9A to 9I. This has direct impact on the printing fidelity as evident by the relationship between G′ and contact angle shown in FIG. 2F and FIG. 10 [42], [45]. At an initial 1.3 wt % the loss tangent (tan δ=G″/G′) in LVR is close to unity (FIG. 9A) which led to a shallow contact angle of 7.1° and discontinuous lines with large variation in line width (FIG. 2G). At 3 wt % quasi-stable structure could be formed with relatively stronger dominance from G′ and a correspondingly higher tan δ of 3.37, excessive spreading still gave a line width of 1.3 mm (FIG. 2H). A sharp and clear transition occurred between 5 and 6 wt % at which the ink became visually elastic at a tan δ of 4.03 with the ability to maintain its cross-sectional shape after deposition (FIG. 10). Optimal printability is reached at 7 wt % (FIG. 2I) with a line width of 0.9 mm. Further increasing con-centration to 9 wt % (FIG. 2J) led to nozzle clogging due to overwhelmingly high loss modulus and highest tan δ of 4.65, which again created discontinued lines, as well as ink attaching to the print nozzle forming unclean cutoffs.

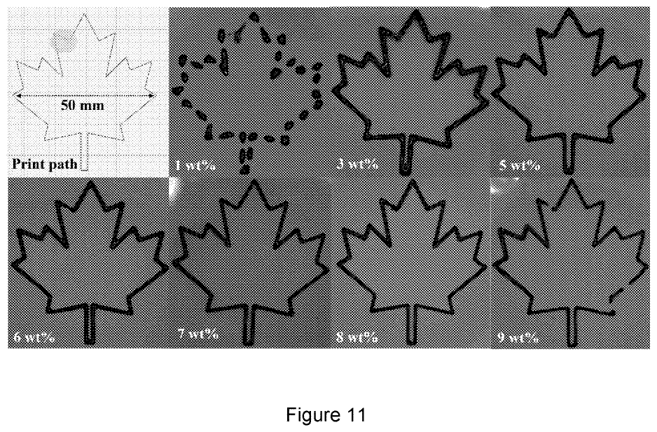

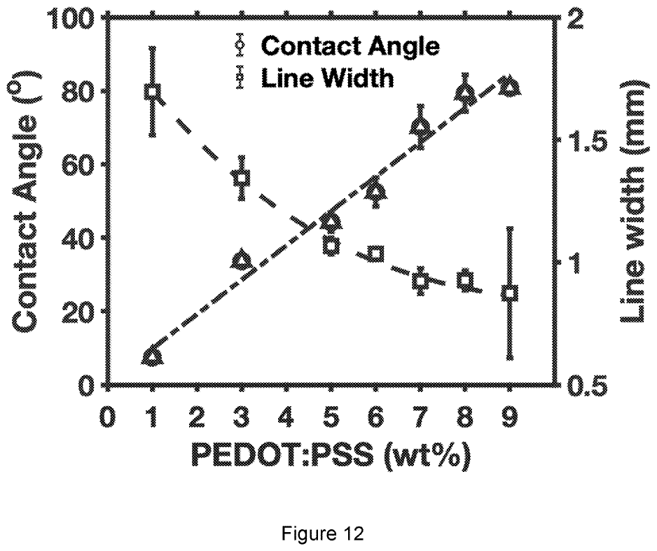

The relationship between contact angle and line width versus ink concentration is quantified in FIGS. 11 and 12. It can be concluded that the printable ink concentration is between 6 and 8 wt % as summarized in FIG. 2C. The two phases system of PEDOT:PSS consists of hydrophilic and insulative PSS backbone decorated by hydrophobic and conductive PEDOT segments [46]. The low electrical conductivity of pristine PEDOT:PSS severely limits it from high-current applications. Therefore, secondary dopants, such as DMSO, are utilized to de-bond PEDOT with PSS. While the doping concentration and annealing parameters have been well studied in previous reports [47], the effect of DMSO on the rheology of printable PEDOT:PSS has never been investigated. To understand this interaction, 7 wt % ink with various DMOS:(PEDOT:PSS) weight ratios are prepared and studied in detail the change in conductivity, rheology, and mechanism of interactions.

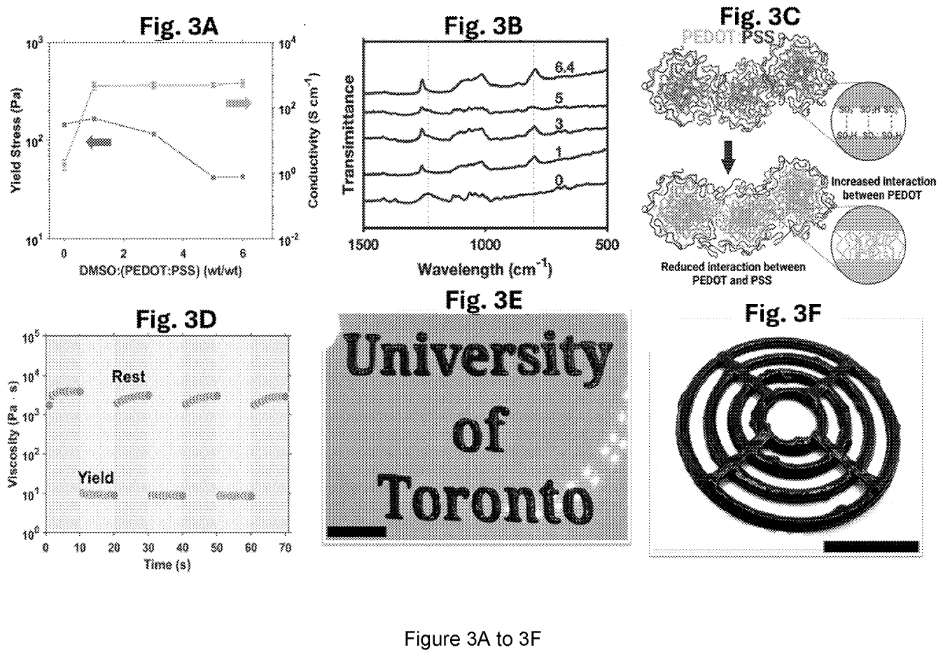

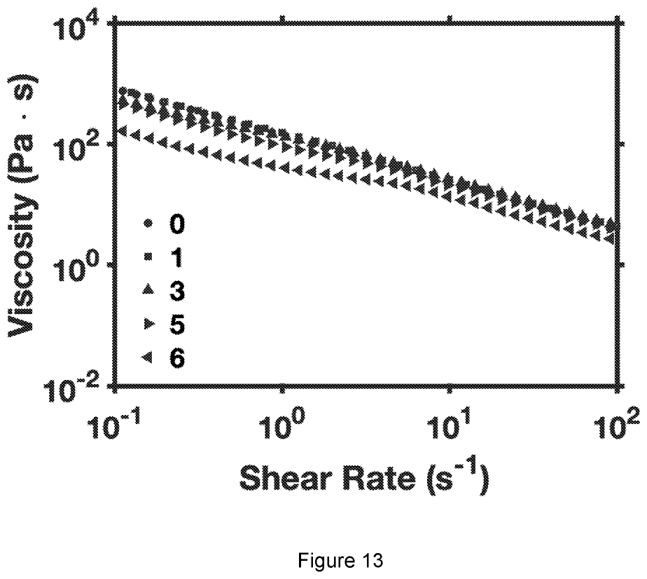

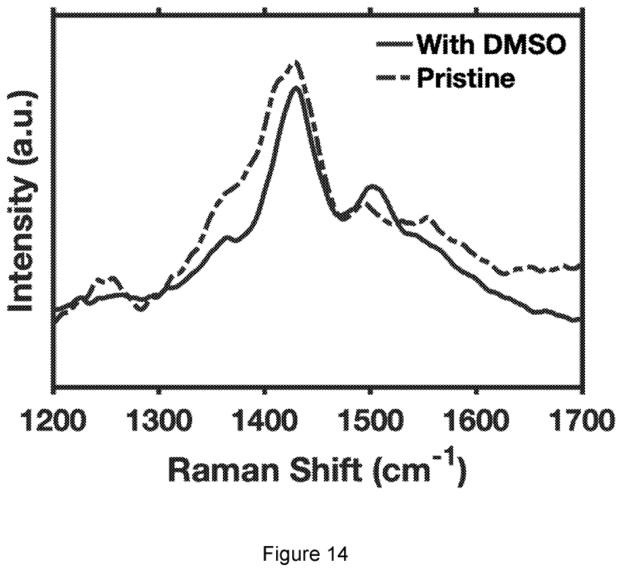

The viscosity of DMSO is twice that of water. However, with the addition of DMSO the ink's yield stress and viscosity decreased as shown in FIG. 3A and FIG. 13. Fourier Transform Infrared (FTIR) Spectroscopy indicates with the addition of DMSO, peak at 1225 cm⁻¹ shifts to the left which corresponds to disruption of SO₃H bonding group from PSS (FIG. 3B) [48]. A new peak is also formed at 797 cm⁻¹ which is ascribed to SO3 stretching vibration [49]. To further elucidate this interaction, Raman Spectroscopy test in conducted which shows the Cα=Cβ asymmetric stretching vibrations blue shifts from 1428 cm⁻¹ for pristine ink to 1432 cm⁻¹ (FIG. 14), which corresponds to a conformation change of the PEDOT segments. This peak also narrows which indicate changes to the oxidation level due to DMSO [50]. Both FTIR and Raman results demonstrate reduced interaction between insulative PEDOT backbone and conductive PSS segments, as well as the formation of interconnected channels between detached PEDOT as depicted in FIG. 3C [51], [52].

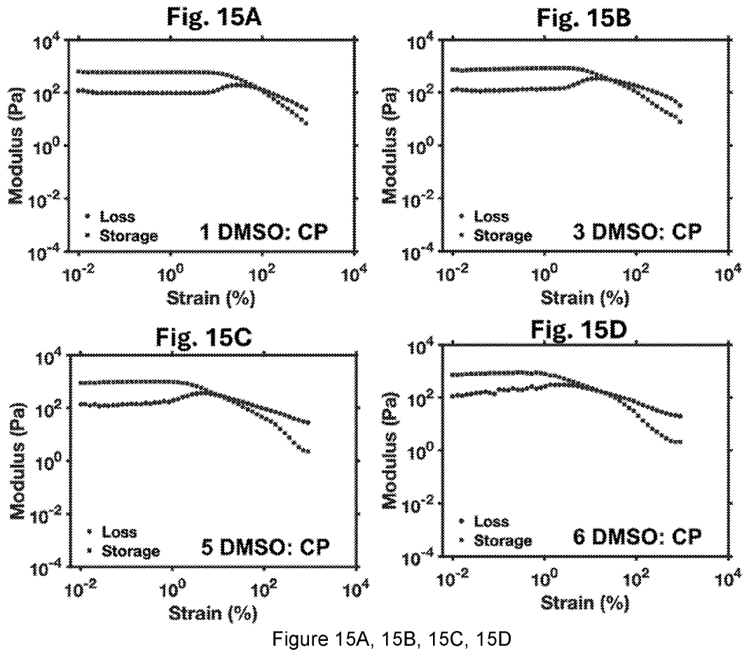

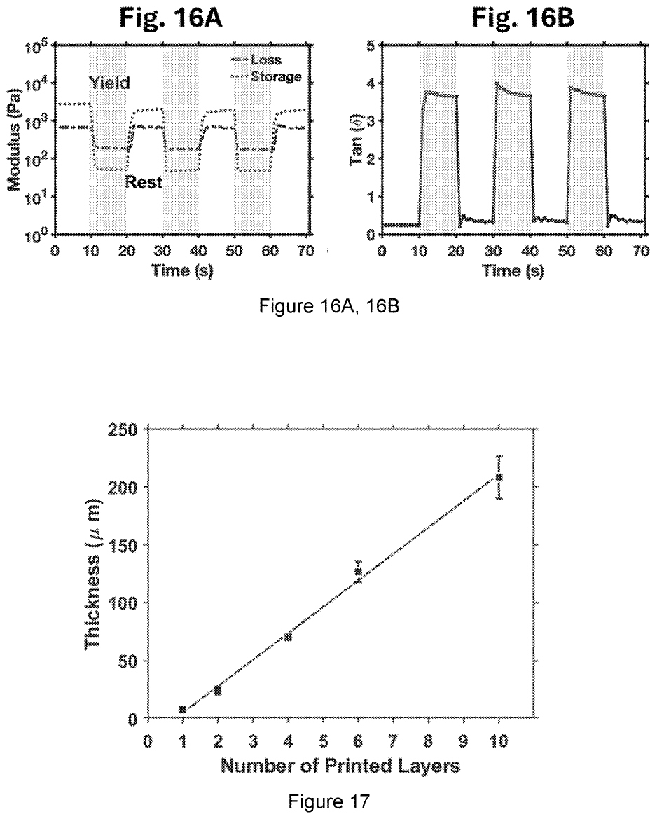

Disruption of the long PSS backbone from the macromolecule consequently decreased the viscosity of the overall system while enhancing the electrical conductivity from 1.86 to 464.19 Scm⁻¹ (FIG. 3A). 7 wt % CP with 3:1 wt ratio of DMSO is chosen as the final formulation since further increasing the DMSO ratio did not show a meaningful enhancement to electrical conductivity but induced weaker adhesion between the ink and substrate after all water and solvent are evaporated. Detailed rheology data is shown in FIGS. 15A, 15B, 15C and 15D. To demonstrate the printability of the developed formulation, rheological behavior of the ink is simulated by a resting (0.1 s⁻¹) and yielding phase (100 s⁻¹). As shown in FIG. 15A, viscosity decreased by two orders of magnitude after high shear application, which serves to pro-mote smooth extrusion of the ink. After the shear force was removed the viscoelastic ink gradually recovers its microstructure and viscosity, 50.5% of the viscosity was recovered immediately, and 79.2% of the same after 10 s of resting. This observation validated the possibility for the extruded ink to retain its structural integrity without over spreading FIG. 16A. Similar trend is also observed by the dynamic rheological simulation (FIG. 16B.

The superior printability of the ink formulation enabled printing of various structures including a single layer of “University of Toronto” text which could serve as conductive circuits for micro-LED lightbulbs (FIG. 3E and overhang lines (FIG. 3F). Finally, MEX of viscous CP gel facilitate the capability to attain active material with unprecedented areal mass loading that is 200 times higher than previously reported patterning technique (Table 2).

TABLE 2
Comparison of areal mass loading of PEDOT:PSS
material with different deposition method.

| | Mass | | |
|---|---|---|---|
| | Loading | | |
| Material | (mg cm⁻²) | Deposition Method | Ref. |
| PEDOT:PSS - MnO₂ | 8.5 | Co-electro-deposition | [2] |
| PEDOT:PSS - GN | 8.49 | Bar-coating | [3] |
| PEDOOT:PSS - rGO | 2.4 | Spray deposition | [4] |
| PEDOT:SS - PVA | 0.975 | Mold casting | [5] |
| PEDOT:PSS - rGO | 4 | Casting | [6] |
| PEDOT:PSS - V₂O₅ | 1 | Blade-coating | [7] |
| PEDOT:PSS - CF | 0.2 | Dip-coating | [8] |
| PEDOT:PSS - MXene - | 5 | Drop cast and vacuum filtration | [9] |
| Fe₂O₃—MoS₂ | | | |
| PEDOT:PSS - SWCNT | 8 | Vacuum filtration | [10] |
| PEDOT:PSS - MnO₂—AgNP | 0.2 | Drop casting | [11] |
| PEDOT:PSS - RuO₂ - GN | 3 | Screen printing | [12] |
| PEDOT:PSS - AgNW—MnO₂ | 0.64 | Electrodeposition | [13] |
| PEDOT:PSS | 1585.5 | Direct ink writing (10 layers) | This |
| | | | work |

Abbreviations are listed as: GN: graphene, rGO: reduced graphene oxide, PVA: poly(vinyl-alcohol), CF: carbon fiber, SWCNT: single wall carbon nano tube, AgNW: silver nano wires.

These capabilities are highly beneficial for energy storage devices based on planar architecture. The high electrical conductivity could allow CP to serve as both current collector and electrodes, and the excellent print-ability allow for stacking of layered electrodes to promote more exposed active surface area to electrolyte along its thickness [45], [53], [54]. PEDOT:PSS has been utilized extensively as the active material for MSCs due to the formation of electric double layers along the PEDOT and PSS-phase boundaries [55-59]. To demonstrate the potential application of MEX with CP, multi-layered interdigitated MSCs are printed and then dry annealed to obtain a film energy storage device with varying thickness which provided more charge storage sites for a higher areal energy density (FIG. 17).

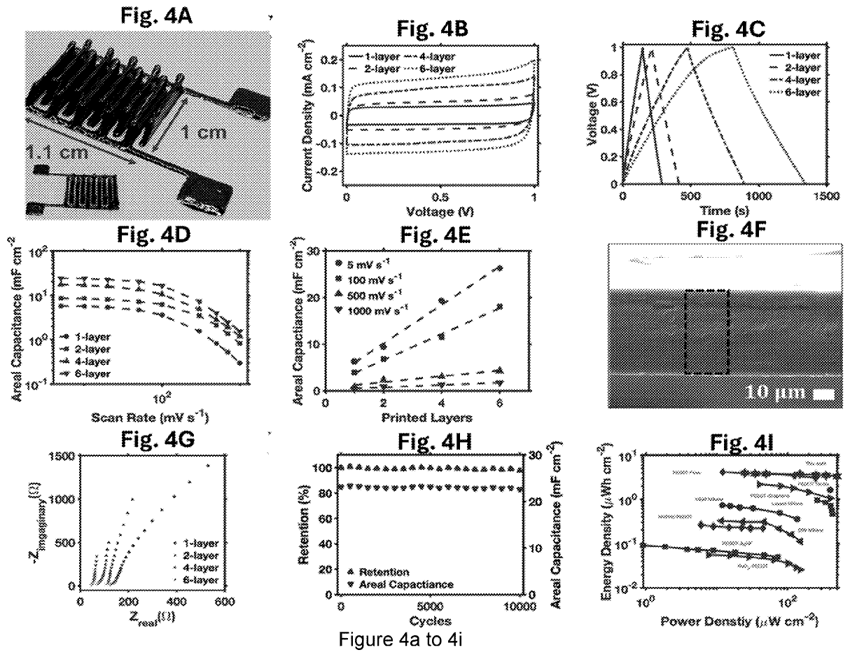

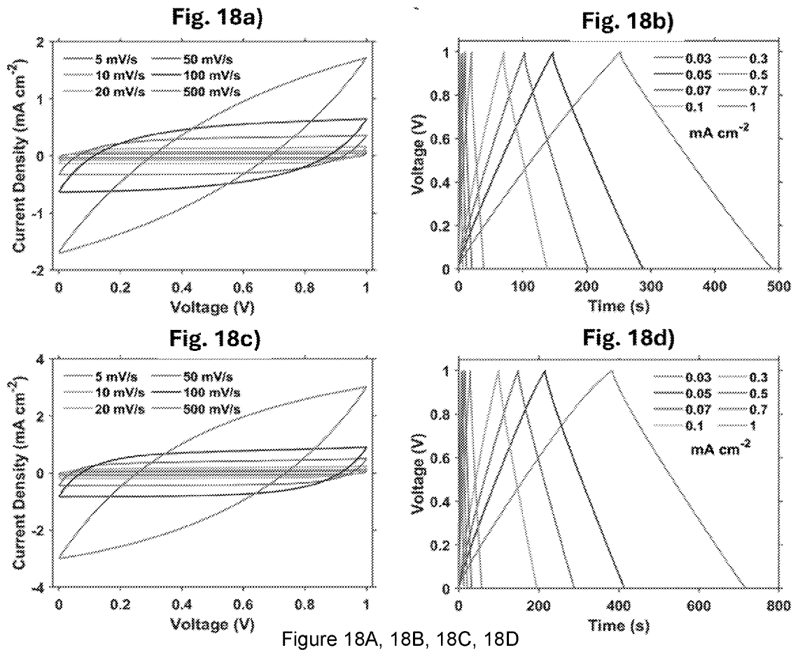

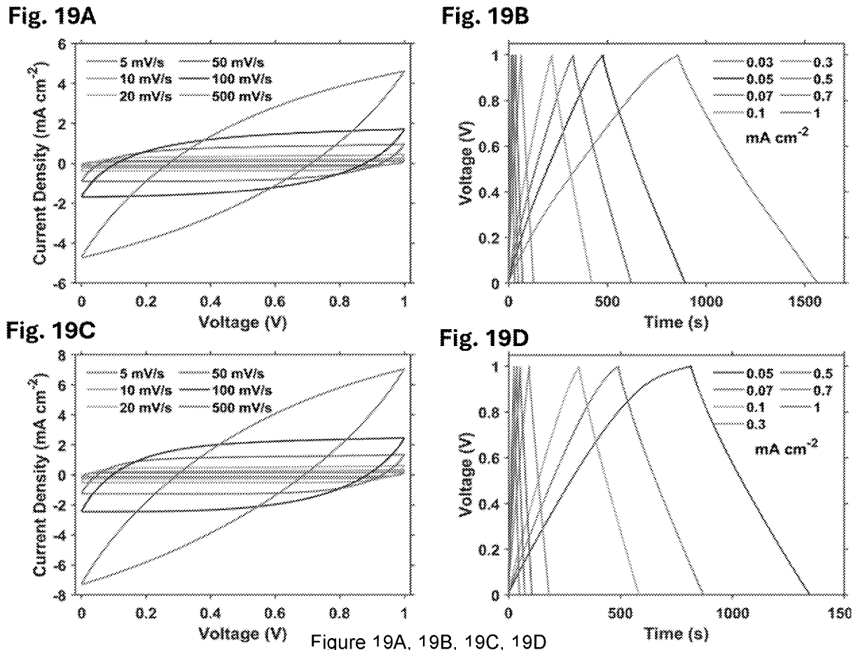

These MSCs are characterized using a two-electrode setup without any current collector. The ability to precisely dose more active materials per unit area requires favorable viscoelastic properties of the ink to ensure the stability of the printed structure. The developed CP ink enabled the printing of MSCs with a 10-layer thickness as shown in FIG. 4A. However, it is observed that when layers exceeded six, annealing weakened the adhesion between electrodes and Kapton substrate. The CV curves for 1-, 2-, 4- and 6-layer MSCs at 5 mV s⁻¹ are shown in FIG. 4B. The capacitive charge storage behaviors of all MSCs can be deduced from the quasi-rectangular shape of the CV curves, with increasing current densities as the number of printed layers increased, indicating of improvement in capacitance. FIG. 4C shows the CD curves for all MSCs at 0.05 mA cm−2, a similar increase is observed as the discharge time of 1, 2, 4 and 6-layer MSCs are 139, 197, 421, and 528 s respectively. Detailed CV and CD data are shown in FIGS. 18 and 19, both showing ideal rectangular CV and triangular CD curves.

To illustrate the advantage of printing in the third dimension using CP, areal capacitance over scan rate is first calculated as shown in FIG. 4D, these data are then plotted against the number of printed layers as shown in FIG. 4E. At 5 mV s⁻¹ the capacitance increased from 6.3 mF of 1-layer to 26.3 mF of 6-layer MSC. Most importantly, a perfectly linear relationship is observed across all scan rates, indicating the ability to precisely tailor device behavior based on the application requirements. SEM image along the thickness of the 6-layer MSC shows a seamless fusion between deposited layers due to carefully optimized elastic modulus (FIG. 4F), this enabled the same through-plane and in-plane conductivity, which could be the key factors contributing to the linear increase in capacitance across all scan rate domain. However, this dense morphology also limits effective surface area of the electrode and hinders ion transportation pathways [60].

The ability to linearly enhance device performance is a unique trait of the CP-based MSCs, whereas devices printed with 2D material such as MXene are known to suffer from rapid decline in capacitance at high rates due to the reduced through-plane conductivity from flake alignment during extrusion [42]. This advantage is not only limited to benefit 3D MSCs but can also be employed by other applications such as 3D batteries and 3D printed aerogels for thermoelectric energy harvesting. EIS results of the multi-layer MSCs are shown as Nyquist plots in FIG. 4G.

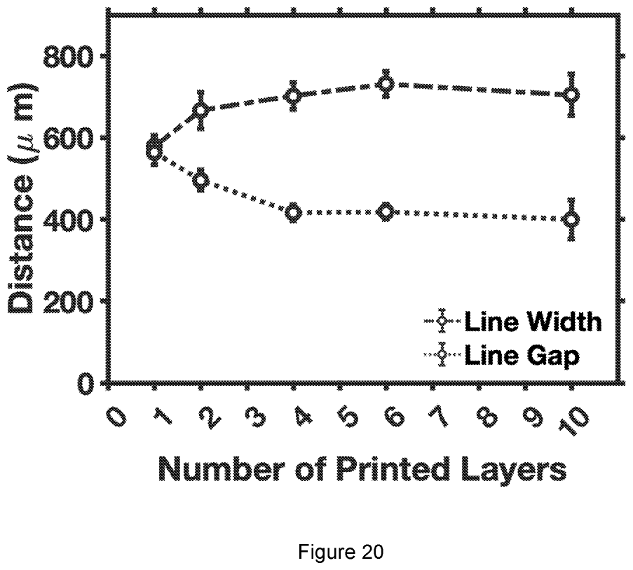

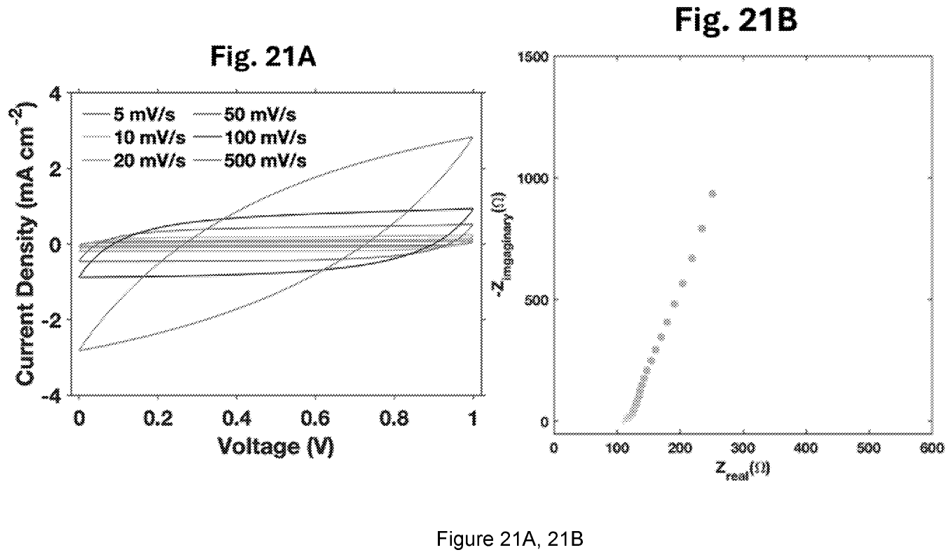

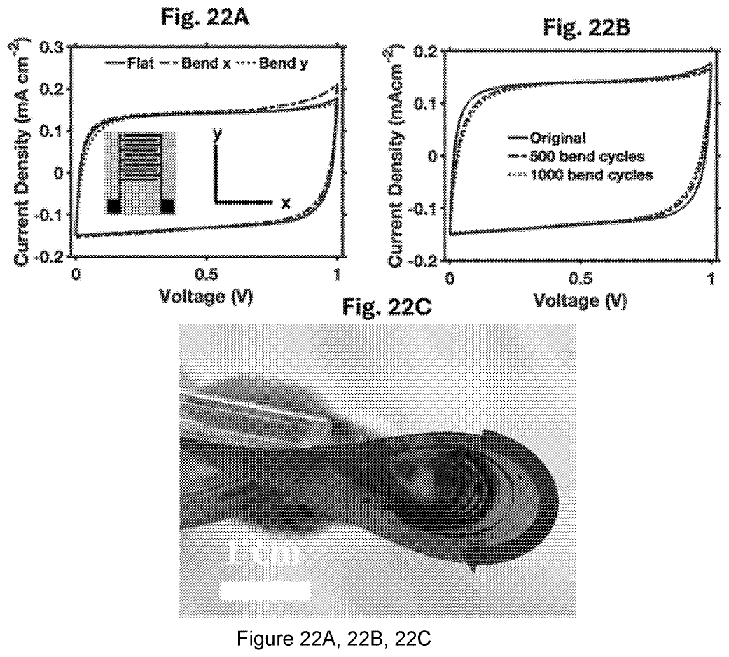

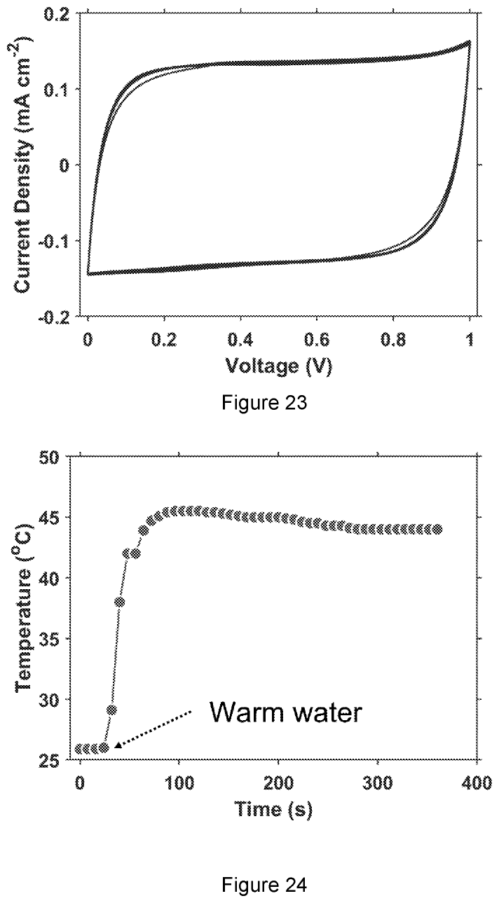

The Equivalent Series Resistance (ESR) decreased from 104.9 to 39Ω between 1 and 6-layer MSCs, which can improve overall device efficiency. This could be from the weight of subsequent layers pushing the bottom layer to expand in the in-plane direction, which slightly decreased the gap distance between electrodes to facilitate faster ion transport (FIG. 20). However, this is not the underlying mechanism for the increased areal capacitance as evident by the miniscule difference in gap distance between 4-layer and 6-layer MSC as well as discussion in FIG. 21. Despite the unprecedented thickness of the CP-based MSCs, the 6-layer MSC is still able to maintain excellent electrochemical stability during and after bending cycles with a radius of curvature of 0.16 cm⁻¹ in different orientations (FIG. 22), as well as retaining 97.8% of its initial capacitance after 10,000 cycles of charge and discharge (FIG. 4H and FIG. 23).

Finally, the areal energy and power densities of the 6-layer MSC is calculated and compared to recently reported devices in Ragone plots shown in FIG. 4I. A near constant energy density of 3.8 μWh cm⁻² was achieved between 25 and 500 μW cm⁻² power density, indicating the MSCs' ability to discharge at different speed with minimal energy loss. Due to MEX's ability to dose large mass loading of active material rapidly and precisely, the performance of the demonstrated MSCs is outstanding compared to other works in literature. Most importantly, the ability to print in the third dimension allowed the MSCs to outperform MSCs printed with 2D MXene, which is a material well-known to have the highest specific capacitance to date [61]. To demonstrate the potential implementation of the printed 3D MSCs as the energy source for wearable electronics, multiple MSCs are printed in series to fulfill the voltage requirements for various wearable electronic devices. First, an illuminating wristband is constructed and powered by 3 MSCs in series.

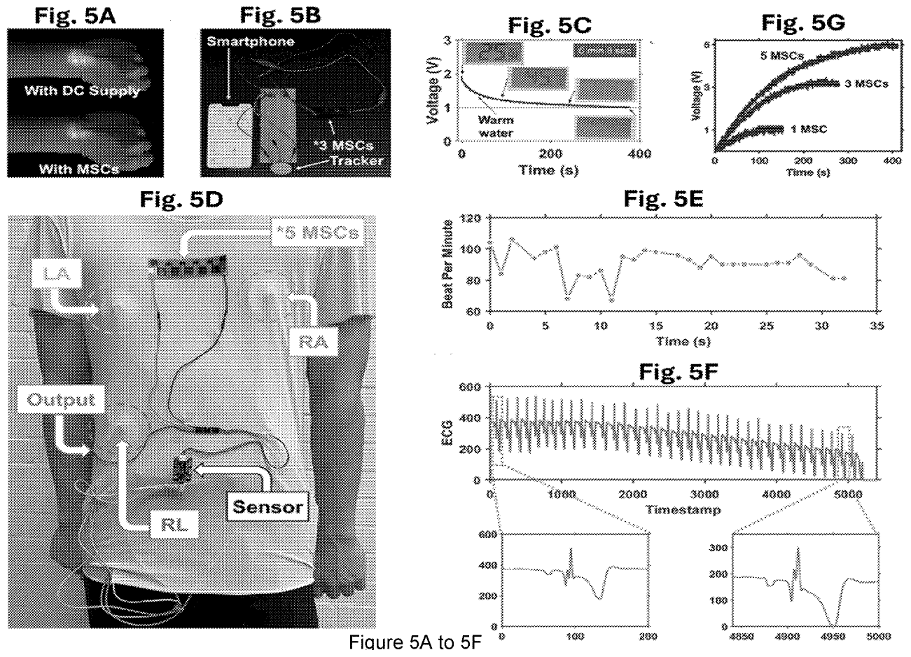

As a result of the MSCs' high-power density, there is minimal dimming in peak luminous intensity as compared to a constant DC supply (FIG. 5A). Next, the coin battery of a commercial miniature tracking device is removed, which includes Bluetooth Low Energy (BLE), Near Field Communication (NFC), Ultra Wide Band (UWB) Transceiver, and accelerometer modules. Three of the MSCs can power the tracker to send location information to a smartphone for 25 min (FIG. 5B). To illustrate the diminish of cell voltage, temperature sensor with an LCD screen is powered using two MSCs (FIG. 5Cc). The MSCs can power the sensor for approximately six minutes while detecting the temperature of a glass of warm water in the process (FIG. 24). The LCD display intensity gradually diminished until the minimum operating voltage of 1 V is reached.

To further exemplify the ability of the printed MSCs as the energy source for wearable electronic devices, five MSCs are printed in series to power an electrocardiogram (ECG) sensor. The exceptional flexibility and lightweight of the MSCs allowed them to be attached to a shirt. The MSCs then provided power to an ECG sensor, which includes an integrated signal conditioning block to extract, amplify, and filter small biopotential signals (FIG. 5D). After fully charged, the MSCs can provide roughly 30 s of heart rate monitoring (FIG. 5E). Although the ECG signal attenuates during this interval, the actual ECG waveform remains relatively constant at the beginning and the end of the cycle (FIG. 5F).

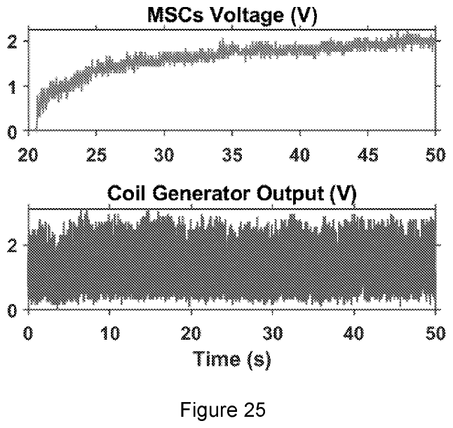

As the last set of demonstrations, MSCs are charged with different mobile energy harvesters. First, the voltage output of different solar cells is matched with the corresponding number of MSCs to observe their charging behavior (FIG. 5G). One, three, and five MSCs can be fully charged in 154, 279, and 411 s, respectively. Next, to show that the MSCs can be incorporated with low frequency and high amplitude body energy [62], a squeeze-handle flashlight is modified to directly charge the MSCs with the electrical current created through electromagnetic induction. The system is excited at two Hertz to mimic natural walking motion and observed a DC output between 0.3 and 3 V at a maintainable value of 2 V. The MSCs are capable of being fully charged within approximately 46 s at this low frequency condition (FIG. 25).

### CONCLUSION

In an embodiment there is provided a method of preparing a flowable electrically conductive PEDOT:PSS polymeric gel that comprises adding macroscopic super-absorbent particles to an aqueous liquid PEDOT:PSS solution to form a mixture. The method includes extracting water from the mixture by incubating the mixture at a preselected temperature for a preselected period of time for allowing the macroscopic super-absorbent particles to absorb the water to a preselected saturation of the macroscopic super-absorbent particles to produce a the flowable electrically conductive PEDOT:PSS polymeric gel. The water-saturated macroscopic super-absorbent-particles are then removed from the PEDOT:PSS polymeric gel.

In an embodiment from about 3 to about 6 grams of macroscopic super-absorbent particles are added to about 80 to about 150 grams of the aqueous liquid PEDOT:PSS solution.

In an embodiment about 4 grams of macroscopic super-absorbent particles are added to about 100 grams of the aqueous liquid PEDOT:PSS solution.

In an embodiment the mixture is incubated at a temperature in a range from about 5 to about 40 degrees Celsius.

In an embodiment the preselected period of time is in a range from about 2 to about 12 hours.

In an embodiment the method further comprises adding a dopant into the flowable electrically conductive PEDOT:PSS polymeric gel, the dopant selected to increase the electrical conductivity of the flowable electrically conductive PEDOT:PSS polymeric gel. In this embodiment the dopant is any one or combination of ethylene glycol, diethylene glycol, dimethyl sulphate, tetrahydrofuran, dimethylformamide, glycerol, methanol, ethanol, and acetone. While the prepared flowable electrically drastically improves the conductivity by about 100 up to about 1000 times.

Alternatively, in this embodiment the dopant is dimethyl sulfoxide.

In an embodiment the flowable electrically conductive PEDOT:PSS polymeric gel is characterized by having a viscosity of between about 500 to about 1000 Pascal seconds, and further comprising diluting to a viscosity in a range from about 10 to about 500 Pascal seconds.

In an embodiment the flowable electrically conductive PEDOT:PSS polymeric gel is diluted to give a viscosity in a range from about 100 to about 200 Pascal seconds.

In an embodiment the macroscopic super-absorbent particles are macroscopic super-absorbent beads.

In an embodiment the macroscopic super-absorbent particles are any one or combination of sodium polyacrylate in the form of beads, gel, fiber, and or film.

In an embodiment the present method provides a product producing using the above-mentioned method.

### REFERENCES

[1] Chotimah, B. Winandianto, M. Munir, I. Kartini, A. Kusumaatmaja, and K. Triyana, “The electrical properties of PEDOT:PSS nanofibers,” AIP Conf Proc, vol. 1755, no. July 2016, pp. 1-6, 2016, doi: 10.1063/1.4958586.
[2] W. Jeong et al., “Enhancing the conductivity of PEDOT:PSS films for biomedical applications via hydrothermal treatment,” Biosens Bioelectron, vol. 171, no. July 2020, p. 112717, 2021, doi: 10.1016/j.bios.2020.112717.
[3] G. Dijk, A. L. Rutz, and G. G. Malliaras, “Stability of PEDOT:PSS-Coated Gold Electrodes in Cell Culture Conditions,” Adv Mater Technol, vol. 5, no. 3, 2020, doi: 10.1002/admt.201900662.
[4] N. Yanagishima, S. Kanehashi, H. Saito, K. Ogino, and T. Shimomura, “Thermoelectric properties of PEDOT:PSS aerogel secondary-doped in supercritical CO2 atmosphere with low thermal conductivity,” Polymer (Guildf), vol. 206, no. August, p. 122912, 2020, doi: 10.1016/j.polymer.2020.122912.
[5] A. K. K. Kyaw et al., “Enhanced Thermoelectric Performance of PEDOT:PSS Films by Sequential Post-Treatment with Formamide,” Macromol Mater Eng, vol. 303, no. 2, pp. 1-7, 2018, doi: 10.1002/mame.201700429.
[6] L. Yu, Z. Fan, Y. Shao, Z. Tian, J. Sun, and Z. Liu, “Versatile N-Doped MXene Ink for Printed Electrochemical Energy Storage Application,” Adv Energy Mater, vol. 9, no. 34, pp. 1-8, 2019, doi: 10.1002/aenm.201901839.
[7] F. Hu, Y. Xue, J. Xu, and B. Lu, “PEDOT-Based Conducting Polymer Actuators,” Front Robot AI, vol. 6, no. November, pp. 1-17, 2019, doi: 10.3389/frobt.2019.00114.
[8] F. Hu, Y. Xue, J. Xu, and B. Lu, “PEDOT-Based Conducting Polymer Actuators,” Front Robot Al, vol. 6, no. November, pp. 1-17, 2019, doi: 10.3389/frobt.2019.00114.
[9] L. Xiong et al., “A Solvent Molecule Driven Pure PEDOT:PSS Actuator,” Macromol Mater Eng, vol. 305, no. 8, pp. 1-8, 2020, doi: 10.1002/mame.202000327.
[10] L. V. Kayser and D. J. Lipomi, “Stretchable Conductive Polymers and Composites Based on PEDOT and PEDOT:PSS,” Advanced Materials, vol. 31, no. 10, pp. 1-13, 2019, doi: 10.1002/adma.201806133.
[11] Y. F. Wang et al., “Fully Printed PEDOT:PSS-based Temperature Sensor with High Humidity Stability for Wireless Healthcare Monitoring,” Sci Rep, vol. 10, no. 1, pp. 1-8, 2020, doi: 10.1038/s41598-020-59432-2.
[12] M. Soni, M. Bhattacharjee, M. Ntagios, and R. Dahiya, “Printed Temperature Sensor Based on PEDOT:PSS-Graphene Oxide Composite,” IEEE Sens J, vol. 20, no. 14, pp. 7525-7531, 2020, doi: 10.1109/JSEN.2020.2969667.
[13] E. Dauzon et al., “Stretchable and Transparent Conductive PEDOT:PSS-Based Electrodes for Organic Photovoltaics and Strain Sensors Applications,” Adv Funct Mater, vol. 30, no. 28, July 2020, doi: 10.1002/adfm.202001251.
[14] H. Sirringhaus et al., “High-resolution inkjet printing of all-polymer transistor circuits,” Science (1979), vol. 290, no. 5499, pp. 2123-2126, 2000, doi: 10.1126/science.290.5499.2123.
[15] E. Bihar, T. Roberts, M. Saadaoui, T. Hervé, J. B. De Graaf, and G. G. Malliaras, “Inkjet-Printed PEDOT:PSS Electrodes on Paper for Electrocardiography,” Adv Healthc Mater, vol. 6, no. 6, 2017, doi: 10.1002/adhm.201601167.
[16] P. Andersson Ersman et al., “All-printed large-scale integrated circuits based on organic electrochemical transistors,” Nat Commun, vol. 10, no. 1, pp. 1-9, 2019, doi: 10.1038/s41467-019-13079-4.
[17] K. Hong, S. H. Kim, A. Mahajan, and C. D. Frisbie, “Aerosol jet printed p- and n-type electrolyte-gated transistors with a variety of electrode materials: Exploring practical routes to printed electronics,” ACS Appl Mater Interfaces, vol. 6, no. 21, pp. 18704-18711, 2014, doi: 10.1021/am504171u.
[18] H. Kigyon et al., “Aerosol Jet Printed, Sub-2 V Complementary Circuits Constructed from P- and N-Type Electrolyte Gated Transistors,” Advanced Materials, vol. 26, no. 41, pp. 7032-7037, 2014.
[19] V. R. Feig et al., “An Electrochemical Gelation Method for Patterning Conductive PEDOT:PSS Hydrogels,” Advanced Materials, vol. 31, no. 39, p. 1902869, 2019.
[20] M. Sessolo et al., “Easy-to-Fabricate Conducting Polymer Microelectrode Arrays,” Advanced Materials, vol. 25, no. 15, pp. 2135-2139, 2013.
[21] S. Wang et al., “Skin electronics from scalable fabrication of an intrinsically stretchable transistor array,” Nature, vol. 555, no. 7694, pp. 83-88, 2018, doi: 10.1038/nature25494.
[22] K. Xie et al., “Delamination and Wrinkling of Flexible Conductive Polymer Thin Films,” Adv Funct Mater, vol. 31, no. 21, May 2021, doi: 10.1002/adfm.202009039.
[23] B. Nan, F. J. Galindo-Rosales, and J. M. F. Ferreira, “3D printing vertically: Direct ink writing free-standing pillar arrays,” Materials Today, vol. 35, pp. 16-24, 2020, doi: https://doi.org/10.1016/j.mattod.2020.01.003.
[24] S. Miao et al., “4D printing of polymeric materials for tissue and organ regeneration,” Materials Today, vol. 20, no. 10, pp. 577-591, 2017, doi: https://doi.org/10.1016/j.mattod.2017.06.005.
[25] J. J. Bowen et al., “Hierarchically porous ceramics via direct writing of preceramic polymer-triblock copolymer inks,” Materials Today, vol. 58, pp. 71-79, 2022, doi: 10.1016/j.mattod.2022.07.002.
[26] X. Gao, M. Zheng, X. Yang, R. Sun, J. Zhang, and X. Sun, “Emerging application of 3D-printing techniques in lithium batteries: From liquid to solid,” Materials Today, 2022, doi: https://doi.org/10.1016/j.mattod.2022.07.016.
[27] Z. Fu, L. Ouyang, R. Xu, Y. Yang, and W. Sun, “Responsive biomaterials for 3D bioprinting: A review,” Materials Today, vol. 52, pp. 112-132, 2022, doi: https://doi.org/10.1016/j.mattod.2022.01.001.
[28] T. Horii, H. Hikawa, M. Katsunuma, and H. Okuzaki, “Synthesis of highly conductive PEDOT:PSS and correlation with hierarchical structure,” Polymer (Guildf), vol. 140, pp. 33-38, 2018, doi: 10.1016/j.polymer.2018.02.034.
[29] K. Namsheer and C. S. Rout, “Conducting polymers: a comprehensive review on recent advances in synthesis, properties and applications,” RSC Adv, vol. 11, no. 10, pp. 5659-5697, 2021, doi: 10.1039/d0ra07800j.
[30] S. Zhang et al., “Room-Temperature-Formed PEDOT:PSS Hydrogels Enable Injectable, Soft, and Healable Organic Bioelectronics,” Advanced Materials, vol. 32, no. 1, pp. 1-7, 2020, doi: 10.1002/adma.201904752.
[31] T. Cheng et al., “3D printable conductive polymer hydrogels with ultra-high conductivity and superior stretchability for free-standing elastic all-gel supercapacitors,” Chemical Engineering Journal, vol. 450, December 2022, doi: 10.1016/j.cej.2022.138311.
[32] H. Yuk et al., “3D printing of conducting polymers,” Nat Commun, vol. 11, no. 1, pp. 4-11, 2020, doi: 10.1038/s41467-020-15316-7.
[33] X. Xin et al., “Freeze-drying and mechanical redispersion of aqueous PEDOT:PSS,” J Appl Polym Sci, vol. 138, no. 5, 2021, doi: 10.1002/app.49774.
[34] J. Liu et al., “Additive Manufacturing of Ti3C2-MXene-Functionalized Conductive Polymer Hydrogels for Electromagnetic-Interference Shielding,” Advanced Materials, vol. 34, no. 5, 2022, doi: 10.1002/adma.202106253.
[35] S. Zhang, Y. Zhou, Y. Liu, G. G. Wallace, S. Beirne, and J. Chen, “All-polymer wearable thermoelectrochemical cells harvesting body heat,” iScience, vol. 24, no. 12, p. 103466, 2021, doi: 10.1016/j.isci.2021.103466.
[36] J. Yang, Q. Cao, X. Tang, J. Du, and T. Yu, “3D-Printed highly stretchable conducting polymer electrodes for flexible supercapacitors,” J Mater Chem A Mater, vol. 9, pp. 19649-19658, 2021, doi: 10.1039/d1ta02617h.
[37] H. J. Walls, S. B. Caines, A. M. Sanchez, and S. A. Khan, “Yield stress and wall slip phenomena in colloidal silica gels,” J Rheol (N Y N Y), vol. 47, no. 4, pp. 847-868, 2003, doi: 10.1122/1.1574023.
[38] Y. Wang et al., “A highly stretchable, transparent, and conductive polymer,” Sci Adv, vol. 3, no. 3, pp. 1-11, 2017, doi: 10.1126/sciadv.1602076.
[39] L. A. Shah et al., “Superabsorbent polymer hydrogels with good thermal and mechanical properties for removal of selected heavy metal ions,” J Clean Prod, vol. 201, pp. 78-87, 2018, doi: 10.1016/j.jclepro.2018.08.035.
[40] S. Kiatkamjornwong, “Superabsorbent Polymers and Superabsorbent Polymer Composites,” ScienceAsia, vol. 33, no. 1, pp. 39-43, 2007, doi: 10.2306/scienceasia1513-1874.2007.33 (s1).039.
[41] A. Akbari et al., “Large-area graphene-based nanofiltration membranes by shear alignment of discotic nematic liquid crystals of graphene oxide,” Nat Commun, vol. 7, 2016, doi: 10.1038/ncomms10891.
[42] J. Orangi, F. Hamade, V. A. Davis, and M. Beidaghi, “3D Printing of Additive-Free 2D Ti3C2Tx (MXene) Ink for Fabrication of Micro-Supercapacitors with Ultra-High Energy Densities,” ACS Nano, vol. 14, no. 1, pp. 640-650, 2020, doi: 10.1021/acsnano.9b07325.
[43] H. Schnablegger and Y. Singh, The SAXS Guide, 3rd ed. 2013.
[44] N. Paxton, W. Smolan, T. Bock, F. Melchels, J. Groll, and T. Jungst, “Proposal to assess printability of bioinks for extrusion-based bioprinting and evaluation of rheological properties governing bioprintability,” Biofabrication, vol. 9, no. 4, 2017, doi: 10.1088/1758-5090/aa8dd8.
[45] Y. Liu et al., “Development of Graphene Oxide/Polyaniline Inks for High Performance Flexible Microsupercapacitors via Extrusion Printing,” Adv Funct Mater, vol. 28, no. 21, May 2018, doi: 10.1002/adfm.201706592.
[46] U. Lang, E. Muller, N. Naujoks, and J. Dual, “Microscopical investigations of PEDOT:PSS thin films,” Adv Funct Mater, vol. 19, no. 8, pp. 1215-1220, 2009, doi: 10.1002/adfm.200801258.
[47] B. Lu et al., “Pure PEDOT:PSS hydrogels,” Nat Commun, vol. 10, no. 1, 2019, doi: 10.1038/s41467-019-09003-5.
[48] J. Park, A. Lee, Y. Yim, and E. Han, “Electrical and thermal properties of PEDOT:PSS films doped with carbon nanotubes,” Synth Met, vol. 161, no. 5-6, pp. 523-527, 2011, doi: 10.1016/j.synthmet.2011.01.006.
[49] W. Zhu, X. Ma, M. Gou, D. Mei, K. Zhang, and S. Chen, “3D printing of functional biomaterials for tissue engineering,” Curr Opin Biotechnol, vol. 40, pp. 103-112, 2016, doi: 10.1016/j.copbio.2016.03.014.
[50] M. Horikawa et al., “The development of a highly conductive PEDOT system by doping with partially crystalline sulfated cellulose and its electric conductivity,” J. Mater. Chem. C, vol. 3, no. 34, pp. 8881-8887, 2015, doi: 10.1039/C5TC02074C.
[51] I. Lee, G. W. Kim, M. Yang, and T. S. Kim, “Simultaneously Enhancing the Cohesion and Electrical Conductivity of PEDOT:PSS Conductive Polymer Films using DMSO Additives,” ACS Appl Mater Interfaces, vol. 8, no. 1, pp. 302-310, 2016, doi: 10.1021/acsami.5b08753.
[52] I. Cruz-Cruz, M. Reyes-Reyes, M. A. Aguilar-Frutis, A. G. Rodriguez, and R. López-Sandoval, “Study of the effect of DMSO concentration on the thickness of the PSS insulating barrier in PEDOT:PSS thin films,” Synth Met, vol. 160, no. 13-14, pp. 1501-1506, 2010, doi: 10.1016/j.synthmet.2010.05.010.
[53] Y. Z. Zhang et al., “Printed supercapacitors: Materials, printing and applications,” Chemical Society Reviews, vol. 48, no. 12. Royal Society of Chemistry, pp. 3229-3264 Jun. 21, 2019. doi: 10.1039/c7cs00819h.
[54] D. Li, S. Yang, X. Chen, W. Y. Lai, and W. Huang, “3D Wearable Fabric-Based Micro-Supercapacitors with Ultra-High Areal Capacitance,” Adv Funct Mater, vol. 31, no. 50, December 2021, doi: 10.1002/adfm.202107484.
[55] H. Wang et al., “Energy storing bricks for stationary PEDOT supercapacitors,” Nat Commun, vol. 11, no. 1, pp. 1-9, 2020, doi: 10.1038/s41467-020-17708-1.
[56] J. Cárdenas-Martínez, B. L. España-Sánchez, R. Esparza, and J. A. Ávila-Niño, “Flexibleand transparent supercapacitors using electrospun PEDOT:PSS electrodes,” Synth Met, vol. 267, no. June 2020, doi: 10.1016/j.synthmet.2020.116436.
[57] J. Zhang et al., “Fast and scalable wet-spinning of highly conductive PEDOT:PSS fibers enables versatile applications,” J Mater Chem A Mater, vol. 7, no. 11, pp. 6401-6410, 2019, doi: 10.1039/c9ta00022d.
[58] A. V. Volkov et al., “Understanding the Capacitance of PEDOT:PSS,” Adv Funct Mater, vol. 27, no. 28, pp. 1-10, 2017, doi: 10.1002/adfm.201700329.
[59] T. Li, T. Chen, X. Shen, H. H. Shi, and H. E. Naguib, “A binder jet 3D printed MXene composite for strain sensing and energy storage application,” Nanoscale Adv, vol. 4, pp. 916-925, 2022, doi: 10.1039/d1na00698c.
[60] T. Cheng, Y. W. Wu, Y. L. Chen, Y. Z. Zhang, W. Y. Lai, and W. Huang, “Inkjet-Printed High-Performance Flexible Micro-Supercapacitors with Porous Nanofiber-Like Electrode Structures,” Small, vol. 15, no. 34, August 2019, doi: 10.1002/smll.201901830.
[61] M. Ghidiu, “conductive 2d titanium carbide clay with high volumetric capacitance.” Nature, p. 78, 2014.
[62] Z. Li, T. Li, Z. Yang, and H. E. Naguib, “Toward a 0.33 W piezoelectric and electromagnetic hybrid energy harvester: Design, experimental studies and self-powered applications,” Appl Energy, vol. 255, p. 113805, December 2019, doi: 10.1016/J.APENERGY.2019.113805.
[63] W. Yan, J. Li, G. Zhang, L. Wang, and D. Ho, “A synergistic self-assembled 3D PEDOT:PSS/graphene composite sponge for stretchable microsupercapacitors,” J Mater Chem A Mater, vol. 8, no. 2, pp. 554-564, 2020, doi: 10.1039/c9ta07383c.
[64] L. Manjakkal, A. Pullanchiyodan, N. Yogeswaran, E. S. Hosseini, and R. Dahiya, “A Wearable Supercapacitor Based on Conductive PEDOT:PSS-Coated Cloth and a Sweat Electrolyte,” Advanced Materials, vol. 32, no. 24, 2020, doi: 10.1002/adma.201907254.
[65] C. (John) Zhang et al., “Highly flexible and transparent solid-state supercapacitors based on Ru02/PEDOT:PSS conductive ultrathin films,” Nano Energy, vol. 28, pp. 495-505, 2016, doi: 10.1016/j.nanoen.2016.08.052.
[66] S. B. Singh, T. Kshetri, T. I. Singh, N. H. Kim, and J. H. Lee, “Embedded PEDOT:PSS/AgNFs network flexible transparent electrode for solid-state supercapacitor,” Chemical Engineering Journal, vol. 359, no. November 2018, pp. 197-207, 2019, doi: 10.1016/j.cej.2018.11.160.
[67] C. (John) Zhang et al., “Additive-free MXene inks and direct printing of micro-supercapacitors,” Nat Commun, vol. 10, no. 1, pp. 1-9, 2019, doi: 10.1038/s41467-019-09398-1.
[68] D. Yuan et al., “Twisted yarns for fiber-shaped supercapacitors based on wetspun PEDOT:PSS fibers from aqueous coagulation,” J Mater Chem A Mater, vol. 4, no. 30, pp. 11616-11624, 2016, doi: 10.1039/c6ta04081k.
[69] J. Ma et al., “Aqueous MXene/PH1000 Hybrid Inks for Inkjet-Printing Micro-Supercapacitors with Unprecedented Volumetric Capacitance and Modular Self-Powered Microelectronics,” Advanced Ener, vol. 2100746, pp. 1-9, 2021, doi: 10.1002/aenm.202100746.
[70] N. Kurra, B. Ahmed, Y. Gogotsi, and H. N. Alshareef, “MXene-on-Paper Coplanar Microsupercapacitors,” Adv Energy Mater, vol. 6, no. 24, pp. 1-8, 2016, doi: 10.1002/aenm.201601372.
[71] Y. Wang et al., “Tunable capacitance in all-inkjet-printed nanosheet heterostructures,” Energy Storage Mater, vol. 36, no. January, pp. 318-325, 2021, doi: 10.1016/j.ensm.2021.01.009.

Therefore what is claimed is:

1. A method of preparing a flowable electrically conductive PEDOT:PSS polymeric gel, comprising:
adding macroscopic super-absorbent particles to an aqueous liquid PEDOT:PSS solution to form a mixture;
extracting water from the mixture of aqueous liquid PEDOT:PSS solution and the macroscopic super-absorbent particles by incubating the mixture at a preselected temperature for a preselected period of time for allowing the macroscopic super-absorbent particles to absorb the water to a preselected saturation of the macroscopic super-absorbent particles to produce the flowable electrically conductive PEDOT:PSS polymeric gel; and
removing the water-saturated macroscopic super-absorbent-particles.

2. The method according to claim 1, wherein from about 3 to about 6 grams of macroscopic super-absorbent particles are added to about 80 to about 150 grams of the aqueous liquid PEDOT:PSS solution.

3. The method according to claim 1, wherein about 4 grams of macroscopic super-absorbent particles are added to about 100 grams of the aqueous liquid PEDOT:PSS solution.

4. The method according to claim 1, wherein the mixture is incubated at a temperature in a range from about 5 to about 40 degrees Celsius.

5. The method according to claim 1, wherein the preselected period of time is in a range from about 2 to about 12 hours.

6. The method according to claim 1, further comprising adding a dopant into the flowable electrically conductive PEDOT:PSS polymeric gel, the dopant selected to increase the electrical conductivity of the flowable electrically conductive PEDOT:PSS polymeric gel.

7. The method according to claim 6, wherein the dopant is any one or combination of ethylene glycol, diethylene glycol, dimethyl sulphate, tetrahydrofuran, dimethylformamide, glycerol, methanol, ethanol, and acetone.

8. The method according to claim 6, wherein the dopant is dimethyl sulfoxide.

9. The method according to claim 6, wherein the flowable electrically conductive PEDOT:PSS polymeric gel is characterized by having a viscosity of between about 500 to about 1000 Pascal seconds and further comprising diluting to a viscosity in a range from about 10 to about 500 Pascals seconds.

10. The method according to claim 9, wherein the flowable electrically conductive PEDOT:PSS polymeric gel is diluted to give a viscosity in a range from about 100 to about 200 Pascal seconds.

11. The method according to claim 1, wherein the macroscopic super-absorbent particles are macroscopic super-absorbent beads.

12. The method according to claim 11, wherein the macroscopic super-absorbent particles are any one or combination of sodium polyacrylate in the form of beads, gel, fiber, and or film.

13. A product produced using the method of claim 1.
